(19) United States
(12) Patent Application Publication
(10) Pub. No.: US 2015/0252991 A1
(43) Pub. Date: Sep. 10, 2015

(54) STANDING POLE TYPE LED LIGHT

(71) Applicant: Star Electrical Equipment Co., Ltd., Xiamen City (CN)

(72) Inventor: Guanghui LI, Xiamen City (CN)

(73) Assignee: STAR ELECTRICAL EQUIPMENT CO., LTD., Xiamen City (CN)

(21) Appl. No.: 14/199,981

(22) Filed: Mar. 6, 2014

(51) Int. Cl. F21V 29/00; F21V 23/00; F21K 99/00

(52) U.S. Cl. CPC F21V 29/22; F21K 9/135; F21V 23/004; F21K 9/50

(57) ABSTRACT

A standing pole type LED light includes a plastic housing directly injection molded on a surface of a heat sink and both of them being mounted to a base. Two right-angled clamp plates have vertical clamping surfaces that are securely fixed to opposite sides of a lower portion of an LED light board and horizontal carrying surfaces mounted to the wide opening of the heat sink. The vertical reflection pole has four curved reflection faces that are arranged to stand on the reflection base in a symmetric manner. The reflection base is mounted to the horizontal carrying surfaces. The LED light board is inserted between the four curved reflection faces and is connected via a driver circuit mounted in the heat sink to the base. The cover is mounted to a top end of the plastic housing.

### (a) TECHNICAL FIELD OF THE INVENTION

The present invention generally relates to an LED (Light-Emitting Diode) light, and more particularly to a standing pole type LED light.

### (b) DESCRIPTION OF THE PRIOR ART

At the present, a standing pole type LED light is available and is made up of a base, a driver circuit, an LED light board, a heat sink, a vertical reflection pole, and a cover. The base receives the heat sink to mount thereon and the heat sink is composed of a left half and a right half coupled to each other. The vertical reflection pole comprises a reflection base and four curved reflection faces. The four curved reflection faces (arc surfaces) are arranged to stand on the reflection base in a symmetric manner. The reflection base is mounted to the heat sink. The driver circuit is mounted in the heat sink. The LED light board is inserted between the four curved reflection faces of the vertical reflection pole. The LED light board has a lower portion that is clamped between top faces of the left half and the right half and is fixed by means of bolts. The LED light board is connected to the driver circuit and thus connected to the base. The cover is set on and covers the LED light board and the vertical reflection pole and is fixed to a top end of the heat sink.

The above described standing pole type LED light uses the vertical reflection pole to reflect light in order to expand the illumination area and thus enhance the utilization of light, realizing omnidirectional lighting.

However, the above described standing pole type LED has the following drawbacks. The LED light board is clamped by the top faces of the left half and the right half and is fixed by means of bolts so that the contact area is small, the fixing is not secured, and the assembling operation is inconvenient. Further, the heat generated in the operation of the LED light board and the driver circuit is dissipated through the heat sink. The heat sink is often made of a metallic material. This makes it possible for the heat sink to leak electricity and get heated, making the safety poor.

In view of this, the present invention aims to provide an improved structure of the standing pole type LED light.

### SUMMARY OF THE INVENTION

An object of the present invention is to provide a standing pole type LED light, which makes assembling secured and convenient and provides improved product safety.

To achieve the above object, the present invention provides the following solution:

A standing pole type LED light is made up of a base, a plastic housing, a driver circuit, an LED light board, right-angled clamp plates, a heat sink, a vertical reflection pole, and a cover. The plastic housing is formed by through injection molding of a polycarbonate (PC) material directly on a surface of the heat sink. The plastic housing and the heat sink are collectively mounted on the base. The heat sink has a top end forming a wide opening. The driver circuit is mounted in the heat sink. The right-angled clamp plates each comprise a horizontal carrying surface and a vertical clamping surface. The vertical clamping surfaces of the two right-angled clamp plates are securely fixed to opposite sides of a lower portion of the LED light board. The horizontal carrying surfaces of the two right-angled clamp plates are mounted to the wide opening of the heat sink. The vertical reflection pole comprises a reflection base and four curved reflection faces. The four curved reflection faces are arranged to stand on the reflection base in a symmetric manner. The reflection base is mounted to the horizontal carrying surfaces of the fight-angled clamp plates. The LED light board is set between the four curved reflection faces of the vertical reflection pole. The LED light board is connected via the driver circuit to the base. The cover is set on and covers the LED light board and the vertical reflection pole and is mounted to a top end of the plastic housing.

The vertical clamping surfaces of the two right-angled clamp plates are fixed to the opposite sides of the lower portion of the LED light board by means of being fastened with bolts or welding or riveting or adhesive bonding so as to allow heat from the LED light board to be transmitted to the right-angled clamp plates.

Each of the horizontal carrying surfaces comprises a retention hole formed therein and the reflection base of the vertical reflection pole comprises a retention hook formed thereon, whereby the vertical reflection pole is mounted to the horizontal carrying surface by means of engagement between the retention hook and the retention hole. The horizontal carrying surface has a circumferential edge forming a raised rim to which a top rim of the heat sink is coupled.

Each of the horizontal carrying surfaces has an edge that is coupled to a top rim of the heat sink through interference fitting or force fitting to allow heat to transmit from the right-angled clamping boards to the heat sink.

The plastic housing that is injected molded on and covers the heat sink has a thickness of 0.1-2 mm.

With the above arrangement, the present invention uses the two vertical clamping surfaces of the right-angled clamp plates to securely fix the LED light board so as to expand the contact area therebetween, making it more stable and secured. To assemble, the LED light board is first fixed by the right-angled clamp plates and then, the right-angled clamp plates and the LED light board are collectively deposited into the heat sink to be fixed therein. The LED light board is connected to the driver circuit and then, the LED light board is inserted into the vertical reflection pole. The operation is easy. Further, the plastic housing is directly injection-molded on a surface of the metal-made heat sink and there is no gap and no medium existing therebetween. The plastic housing helps prevent electrical leaking and heating and enhances safety.

The present invention makes the fixing structure of the LED light board simple and has a strong feeling of integrity and a low cost.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of the present invention in an assembled form.

FIG. 3 is a cross-sectional view of the present invention in an assembled form.

FIG. 4 is another cross-sectional view of the present invention in an assembled form.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

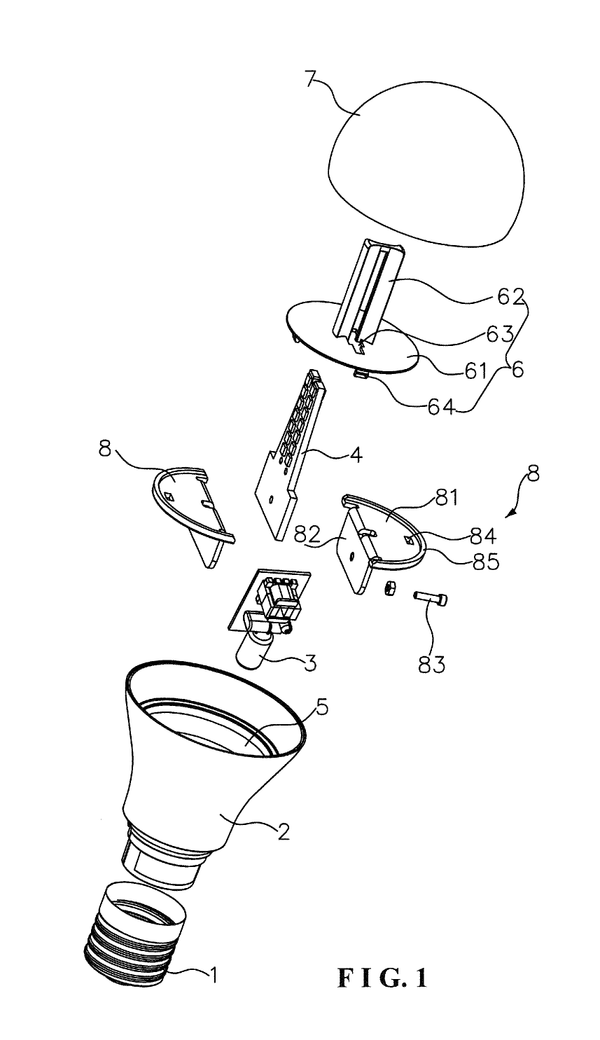

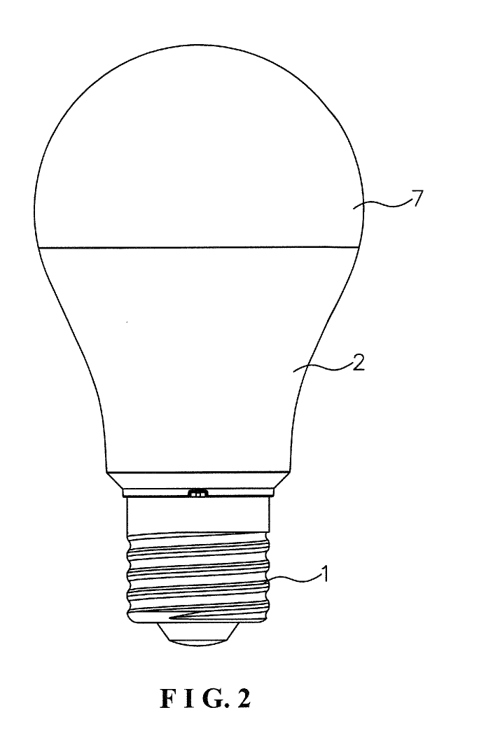

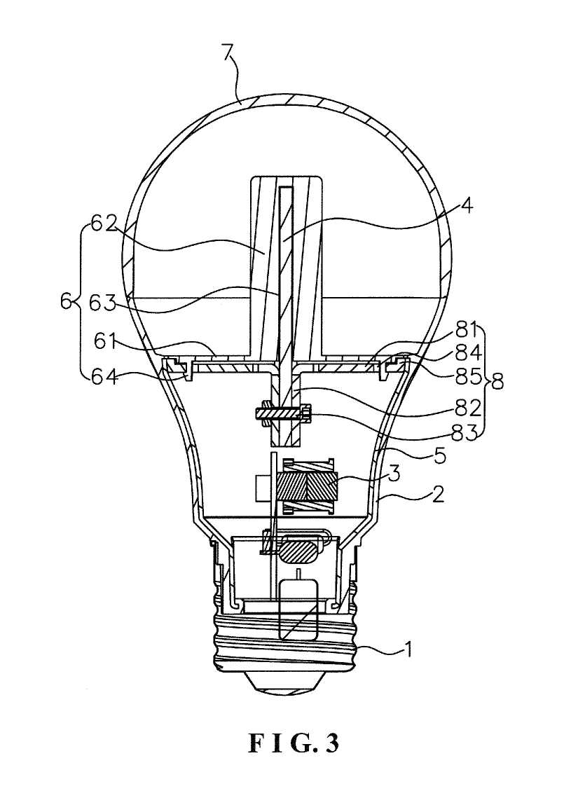

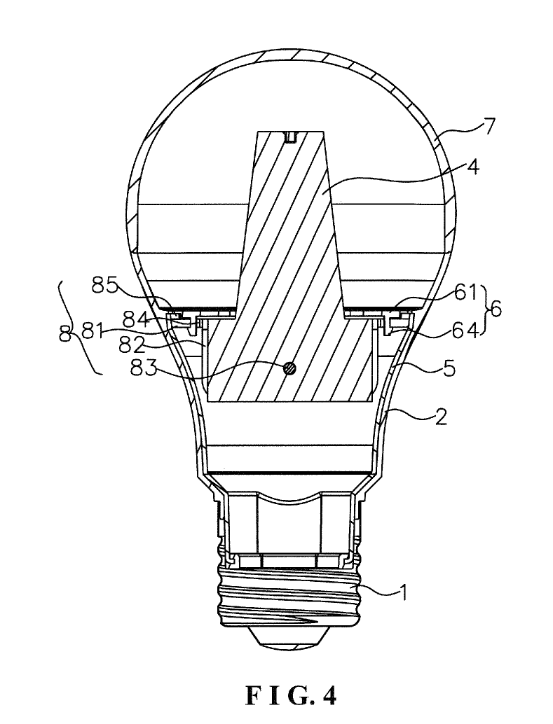

As shown in FIGS. 1-4, the present invention discloses a standing pole type LED light, which comprises a base 1, a plastic housing 2, a driver circuit 3, an LED light board 4, right-angled clamp plates 8, a heat sink 5, a vertical reflection pole 6, and a cover 7.

The plastic housing 2 is formed through direct injection-molding of a polycarbonate material on a surface of the aluminum-made heat sink 5 and, after injection molding, may have a preferred thickness of 0.1-2 mm that covers the aluminum-made heat sink 5 in such a way that there is no gap and no medium existing between the plastic housing 2 and the surface of the aluminum-made heat sink 5, whereby the plastic housing 2 is capable of preventing electricity leaking and heat generating, improving product safety.

The plastic housing 2 and the heat sink 5 are mounted together on the base. The heat sink 5 has a top end that defines a wide opening.

The driver circuit 3 is mounted in the heat sink 5.

The right-angled clamp plates 8 each comprise a horizontal carrying surface 81 and a vertical clamping surface 82. The vertical clamping surfaces 82 of the two right-angled clamp plates 8 are securely fixed to opposite surfaces of a lower portion of the LED light board 4 and can be specifically fixed through being fastened by bolts 83 or welding or riveting or adhesive bonding. The horizontal carrying surfaces 81 of the two right-angled clamp plates 8 are fixed to the wide opening of the heat sink 5 for easy and secured mounting. In the instant embodiment, a circumferential edge of the horizontal carrying surface 81 is formed as a raised rim 85 for mating and fixing with a top rim of the heat sink 5. The raised rim 85 can be fixed to the top rim of the heat sink 5 through interference fitting or force fitting.

The vertical reflection pole 6 comprises a reflection base 61 and four curved reflection faces 62. The curved reflection faces 62 are arranged to stand on the reflection base 61 in a symmetric manner. The reflection base 61 is mounted to the horizontal carrying surfaces 81 of the right-angled clamp plates 8. For easy and secured mounting, in the instant embodiment, the horizontal carrying surface 81 comprises a the retention hole 84 formed therein and the vertical reflection pole 6 comprises a retention hook 64 formed on the reflection base 61, whereby through engagement between the retention hook 64 and the retention hole 84, the vertical reflection pole 6 is fixed to the horizontal carrying surfaces 81.

The LED light board 4 is positioned among the four curved reflection faces 62 of the vertical reflection pole 6. The LED light board 4 is connected to the driver circuit 3 and is connected, via the driver circuit 3, to the base 1. To improve luminance, in the instant embodiment, the four curved reflection faces 62 are formed as reflective arc surfaces corresponding to the LED light board 4. For easy assembling, the reflection base 61 is formed with an insertion slot 63 that receives the LED light board 4 to insert therein.

The cover 7 is set to cover the LED light board 4 and the vertical reflection pole 6 and is mounted to a top end of the plastic housing 2. To assemble the present invention, the two vertical clamping surfaces 82 of the right-angled clamp plates 8 securely fix the LED light board 4 therebetween. The fixing arrangement is of a simple structure, an improved feeling of integrity, and a low manufacturing cost and can be assembled more stably and securely and can be operated in an easier manner.

To use the present invention, the base 1 supplies electricity through the driver circuit 3 to LED chips of the LED light board 4 so as to make the LED chips emitting light. The light transmits through the cover 7 and is subjected to diffusion to achieve lighting. Heat generated in the operation of the LED light board 4 and the driver circuit 3 is dissipated through the heat sink 5. The plastic housing 2 helps prevent electrical leaking and heating.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A standing pole type LED (Light-Emitting Diode) light, characterized by comprising a base, a plastic housing, a driver circuit, an LED light board, right-angled clamp plates, a heat sink, a vertical reflection pole, and a cove, the plastic housing being formed through direction injection molding of a polycarbonate material on a surface of the heat sink, the plastic housing and the heat sink being collectively mounted on the base, the heat sink having a top end forming a wide opening, the driver circuit being mounted in the heat sink, the right-angled clamp plates each comprising a horizontal carrying surface and a vertical clamping surface, the vertical clamping surfaces of the two right-angled clamp plates being securely fixed to opposite sides of a lower portion of the LED light board, the horizontal carrying surfaces of the two right-angled clamp plates being mounted to the wide opening of the heat sink, the vertical reflection pole comprising a reflection base and four curved reflection faces, the four curved reflection faces being arranged to stand on the reflection base in a symmetric manner, the reflection base being mounted to the horizontal carrying surfaces of the right-angled clamp plates, the LED light board being set between the four curved reflection faces of the vertical reflection pole, the LED light board being connected via the driver circuit to the base, the cover being set on and covering the LED light board and the vertical reflection pole and mounted to a top end of the plastic housing.

2. The standing pole type LED light according to claim 1, characterized in that the vertical clamping surfaces of the two right-angled clamp plates are fixed to the opposite sides of the lower portion of the LED light board by means of being fastened with bolts or welding or riveting or adhesive bonding.

3. The standing pole type LED light according to claim 1, characterized in that each of the horizontal carrying surfaces comprises a retention hole formed therein and the reflection base of the vertical reflection pole comprises a retention hook formed thereon, whereby the vertical reflection pole is mounted to the horizontal carrying surface by means of engagement between the retention hook and the retention hole and the horizontal carrying surface has a circumferential edge forming a raised rim to which a top rim of the heat sink is coupled.

4. The standing pole type LED light according to claim 1, characterized in that each of the horizontal carrying surfaces has an edge that is coupled to a top rim of the heat sink through interference fitting or force fitting.

5. The standing pole type LED light according to claim 1, characterized in that the plastic housing that is injected molded on and covers the aluminum-made heat sink has a thickness of 0.1-2 mm.
